(19) United States
(12) Patent Application Publication
(10) Pub. No.: US 2024/0256942 A1
(43) Pub. Date: Aug. 1, 2024

(54) DETERMINING GOLDEN SIGNAL CLASSIFICATIONS USING HISTORICAL CONTEXT FROM INFORMATION TECHNOLOGY (IT) SUPPORT DATA

(71) Applicant: INTERNATIONAL BUSINESS MACHINES CORPORATION, Armonk, NY (US)

(72) Inventors: Ruchi MAHINDRU, Elmsford, NY (US); Amitkumar Manoharrao PARADKAR, Mohegan Lake, NY (US)

(21) Appl. No.: 18/103,039

(22) Filed: Jan. 30, 2023

(51) Int. Cl. G06N 20/00

(52) U.S. Cl. CPC G06N 20/00

(57) ABSTRACT

A method includes: creating, by a processor set, a training dataset using historic information technology (IT) operations data and historic event data of a computer system; training, by the processor set, a machine learning model using the training dataset; receiving, by the processor set, run-time IT operations data of the computer system; determining, by the processor set, a golden signal classification, a cause-effect classification, and an impact using the run-time IT operations and the machine learning model; and generating, by the processor set, a resolution recommendation based on the golden signal classification, the cause-effect classification, and the impact.

### BACKGROUND

Aspects of the present invention relate generally to computer system monitoring and, more particularly, to determining golden signal classifications using historical context from information technology (IT) support data.

Current site reliability engineering (SRE) best practices define golden signals as latency, traffic, errors, and saturation. Latency may be considered as the time it takes a computer system to serve a request. Traffic may be considered as a measure of how much demand is being placed on the computer system. Errors may be considered as the rate of requests that fail in the computer system. And saturation may be considered as how full the services provided by the computer system are at a particular time.

### SUMMARY

In the first aspect of the invention, there is a computer-implemented method including, creating, by a processor set, a training dataset using historic information technology (IT) operations data and historic event data of a computer system; training, by the processor set, a machine learning model using the training dataset; receiving, by the processor set, run-time IT operations data of the computer system; determining, by the processor set, a golden signal classification, a cause-effect classification, and an impact using the run-time IT operations and the machine learning model; and generating, by the processor set, a resolution recommendation based on the golden signal classification, the cause-effect classification, and the impact.

In another aspect of the invention, there is a computer program product including one or more computer readable storage media having program instructions collectively stored on one or more computer readable storage media. The program instructions are executable to: create a training dataset using historic information technology (IT) operations data and historic event data of a computer system; train a machine learning model using the training dataset; receive run-time IT operations data of the computer system; determine a golden signal classification, a cause-effect classification, and an impact using the run-time IT operations and the machine learning model; and generate a resolution recommendation based on the golden signal classification, the cause-effect classification, and the impact.

In another aspect of the invention, there is a system including a processor set, one or more computer readable storage media, and program instructions collectively stored on one or more computer readable storage media. The program instructions are executable to: create a training dataset using historic information technology (IT) operations data and historic event data of a computer system; train a machine learning model using the training dataset; receive run-time IT operations data of the computer system; determine a golden signal classification, a cause-effect classification, and an impact using the run-time IT operations and the machine learning model; and generate a resolution recommendation based on the golden signal classification, the cause-effect classification, and the impact.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a computing environment according to an embodiment of the present invention.

FIG. 2 shows a block diagram of an exemplary environment in accordance with aspects of the invention.

FIG. 3 shows a functional block diagram of operations of a monitoring server in accordance with aspects of the invention.

FIG. 4 shows a functional block diagram of offline operations of a monitoring server in accordance with aspects of the invention.

FIG. 5 shows an example of determining a golden signal classification for training data in accordance with aspects of the invention.

FIG. 6 shows a flowchart of an exemplary method in accordance with aspects of the invention.

### DETAILED DESCRIPTION

Aspects of the present invention relate generally to computer system monitoring and, more particularly, to determining golden signal classifications using historical context from information technology (IT) support data. Golden signals help site reliability engineers classify input signals of computer systems, and this classification helps with diagnosing problems in the systems. For example, latency and error golden signals may be deemed related to symptoms of problems in a computer system, while traffic and saturation golden signals may be indicative of a cause of problems in the system. The site reliability engineers end up manually applying best practices related to golden signals using events arising from run-time IT operations data such as logs, metrics, and traces. As used herein, an event indicates that something has happened which should be brought to the notice of the SRE. It is associated with one or more applications, services, or other managed resources. Events can indicate anomalous behaviour or information. As used herein, an alert comprises plural events that need SRE attention grouped together. It requires (or will require in the future) human or automatic attention and actions toward remediation. Further, an incident is defined as representing a reduction in the quality of a business or service which is represented through one or more alerts.

Exploiting golden signals based purely on run-time IT operations data can lead to missing out on early problem indicators. For example, warning and informational messages are early problem indicators and may be typically missed as they do not have the actual impact tied to them. Using alerts without accurate golden signal and cause-effect classifications leads to extra burden on site reliability engineers to identify root cause alerts for ad-hoc problem diagnosis and resolution application, leading to increased mean time to detect or discover (MTTD) and mean time to repair (MTTR), which may incur service level objective (SLO) violations. This can disadvantageously result in siloed resolutions being recommended at the per alert level instead of at the incident level, without precise knowledge of whether the alert may be cause-related or effect-related.

Implementations of the invention address these problems of conventional approaches by providing an end-to-end system for optimal probable cause identification and resolution recipe recommendation using a derived golden signal, a derived cause-effect, and a derived alert impact in AIOps (Artificial Intelligence for IT Operations). Embodiments include a method to derive a golden signal, cause-effect classification, and alert impact using features spread across historical data. Conventional approaches that focus only on run-time data lack the overall context of a problem as it actually manifested in the environment (e.g., computer system). This is because descriptions of run-time IT operations data (e.g., logs, etc.) by themselves may be insufficient and misleading. For example, an alert that is created by a synchronization object (e.g., when it is informed of the current completion state of the transaction) might be classified as a first type of golden signal (e.g., latency) when classified using only run-time data; however, historical support ticket data associated with this alert might be more related to a second type of golden signal (e.g., saturation). In this way, the historical data can be used to make a more intelligent classification of the alert compared to classification based only on run-time data. Implementations of the invention leverage this by deriving a golden signal that an alert may carry based on the context and the actual impact realized from the historical data. Implementations of the invention also use historical data to determine a cause-effect classification that provides more accurate identification and rank of the probable cause of the alert compared to classification based only on run-time data.

In addition to the above-noted improvements, embodiments include a method for providing domain aware and impact driven alert prioritization and targeted probable cause identification and ranking. Embodiments additionally include a method for providing a resolution recipe recommendation via data driven grouping and ranking at the story level in AIOps. Embodiments further include a method for recommending a cohesive resolution recipe by grouping and ranking the resolutions based on the cause-effect and derived golden signal classification. Hence, recommend resolutions associated with alerts that are classified as “cause” related are prioritized higher (e.g., first), and the resolutions associated with anomalies that are classified as “effect” are prioritized lower (e.g., second).

As will be understood from the present disclosure, implementations of the invention provide a method for classifying golden signals, the method comprising: building a training dataset using stored event information; training a first machine learning model using the training dataset; receiving run-time metadata; assigning a classification to the run-time metadata according to the first machine learning model; generating an ensemble classification according to the classification; and applying the ensemble classification according to a second machine learning model. The method may comprise: receiving feedback according to the application of the ensemble classification; altering the training dataset according to the feedback; and retraining the first machine learning model using the altered dataset. Building of the training dataset may comprise linking input signals, problem identifiers, and problem resolutions across a plurality of stored event information sources. Generating the ensemble classification may comprise combining classifications according to input data elements. Assigning the classification may comprise assigning a classification to metadata according to a problem identifier. The method may comprise: training the first machine learning model using partial dataset representations; and determining an accuracy penalty associated with the partial dataset representation.

Implementations of the invention are necessarily rooted in computer technology. For example, the steps of training a machine learning model using the training dataset and determining a golden signal classification, a cause-effect classification, and an impact using run-time IT operations and the machine learning model are computer-based and cannot be performed in the human mind. Training and using a machine learning model are, by definition, performed by a computer and cannot practically be performed in the human mind (or with pen and paper) due to the complexity and massive amounts of calculations involved. For example, an artificial neural network may have millions or even billions of weights that represent connections between nodes in different layers of the model. Values of these weights are adjusted, e.g., via backpropagation or stochastic gradient descent, when training the model and are utilized in calculations when using the trained model to generate an output in real time (or near real time). Given this scale and complexity, it is simply not possible for the human mind, or for a person using pen and paper, to perform the number of calculations involved in training and/or using a machine learning model.

It should be understood that to the extent implementations of the invention collect, store, or employ personal information provided by or obtained from individuals, such information shall be used in accordance with all applicable laws concerning the protection of personal information. Additionally, the collection, storage, and use of such information may be subject to the consent of the individual to such activity, for example, through “opt-in” or “opt-out” processes as may be appropriate for the situation and type of information. Storage and use of personal information may be in an appropriately secure manner reflective of the type of information, for example, through various encryption and anonymization techniques for particularly sensitive information.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

Computing environment 100 contains an example of an environment for the execution of at least some of the computer code involved in performing the inventive methods, such as the golden signal classifying code shown at block 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IOT) sensor set 125), and network module 115. Remote server 104 includes remote database 130. Public cloud 105 includes gateway 140, cloud orchestration module 141, host physical machine set 142, virtual machine set 143, and container set 144.

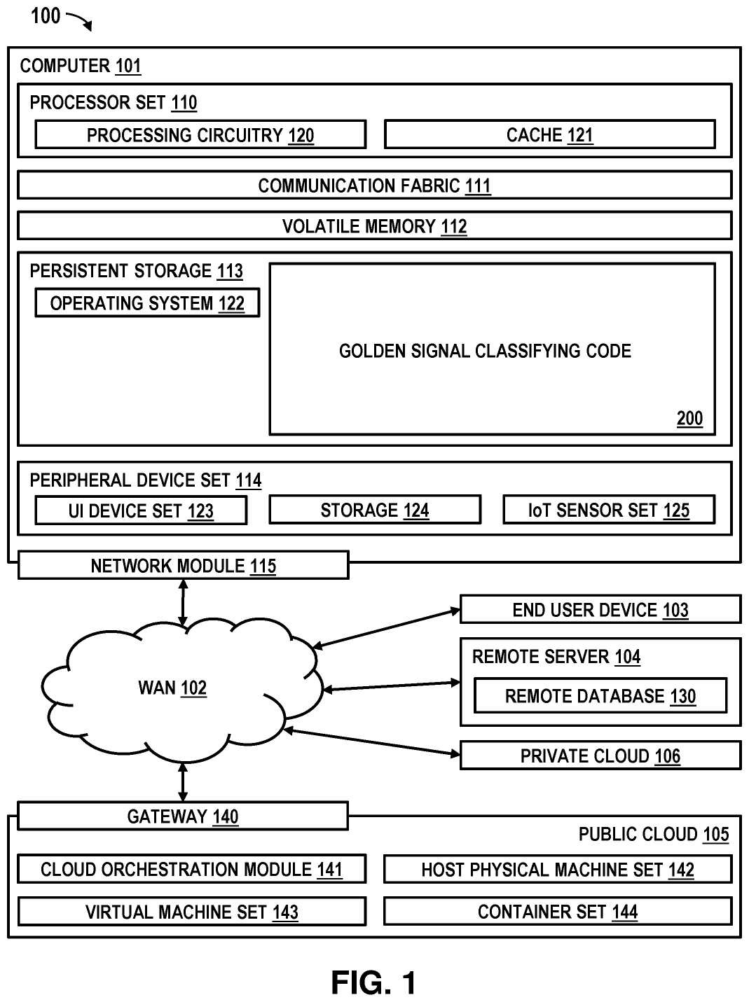

COMPUTER 101 may take the form of a desktop computer, laptop computer, tablet computer, smart phone, smart watch or other wearable computer, mainframe computer, quantum computer, or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community, or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

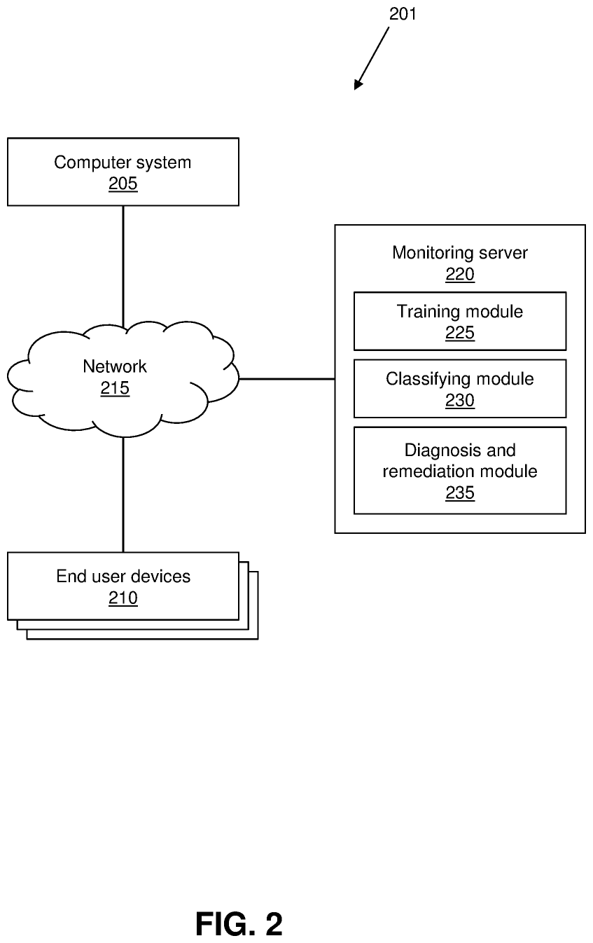

FIG. 2 shows a block diagram of an exemplary environment 201 in accordance with aspects of the invention. In embodiments, environment 201 includes a computer system 205 that provides one or more services to one or more end user devices 210. The computer system 205 may include one or more physical servers, virtual machines running on physical servers, or containers running physical servers that provide services to the end user devices 210. To this end, the computer system 205 may comprise one or more instances of remote server 104, host physical machine set 142, virtual machine set 143, and/or container set 144 of FIG. 1. The end user devices 210 may comprise one or more instances of end user device 103 of FIG. 1. The end user devices 210 may communicate with the computer system 205 over a network 215 such as the WAN 102 of FIG. 1. Non-limiting examples of the types of services the computer system 205 may provide to the end user devices 210 include website hosting, video streaming services, videoconferencing services, and database services. Other types of services may be provided.

With continued reference to FIG. 2, environment includes 201 a monitoring server 220 that is configured to monitor IT operations of the computer system 205. In one example, the monitoring server 220 comprises one or more instances of computer 101 of FIG. 1. In another example, the monitoring server 220 comprises one or more virtual machines or containers running on one or more instances of computer 101 of FIG. 1. The monitoring server 220 may be included in the computer system 205 or may be separate from the computer system 205 and communicate with the computer system 205 via the network 215.

In embodiments, the monitoring server 220 of FIG. 2 comprises a training module 225, a classifying module 230, and a diagnosis and remediation module 235, each of which may comprise modules (e.g., program modules) of the code of block 200 of FIG. 1. These modules of the code of block 200 are executable by the processing circuitry 120 of FIG. 1 to perform the inventive methods as described herein. The monitoring server 220 may include additional or fewer modules than those shown in FIG. 2. In embodiments, separate modules may be integrated into a single module. Additionally, or alternatively, a single module may be implemented as multiple modules. Moreover, the quantity of devices and/or networks in the environment is not limited to what is shown in FIG. 2. In practice, the environment may include additional devices and/or networks; fewer devices and/or networks; different devices and/or networks; or differently arranged devices and/or networks than illustrated in FIG. 2.

In accordance with aspects of the invention, the training module 225 is configured to create a training dataset for a machine learning model and train the machine learning model using the training dataset. In embodiments, the training module 225 creates the training dataset using historic IT operations data from the computer system 205. In embodiments, the training module 225 trains the machine learning model using the training dataset and one or more machine learning algorithms such that the trained machine learning model receives IT operations data as input and outputs a golden signal classification associated with the IT operations data that was input. In this manner, after the machine learning model is trained, it can be used to classify run-time IT operations data with a golden signal classification. Because the model is trained using historic IT operations data, the classifying of run-time IT operations data is based on historical context and not just the information available in the run-time IT operations data itself.

In accordance with aspects of the invention, the classifying module 230 is configured to classify run-time IT operations data with a golden signal classification using the machine learning model from the training module 225. In embodiments, the classifying module 230 receives run-time IT operations data from the computer system 205 and inputs the run-time IT operations data into the machine learning model. The output of the model is a derived golden signal for the run-time IT operations data. In accordance with additional aspects of the invention, the classifying module 230 is configured to determine a cause-effect classification and an impact associated with the derived golden signal for the run-time IT operations data. The golden signal classification, cause-effect classification, and impact determined in this manner are referred to herein as a derived golden signal, derived cause-effect, and derived impact.

In accordance with aspects of the invention, the diagnosis and remediation module 235 is configured to generate a prioritization, probable root cause, and resolution recommendation for the run-time IT operations data that was input into the model. In embodiments, the diagnosis and remediation module 235 generates the prioritization, probable root cause, and resolution recommendation using the derived golden signal, derived cause-effect, and derived impact from the classifying module 230.

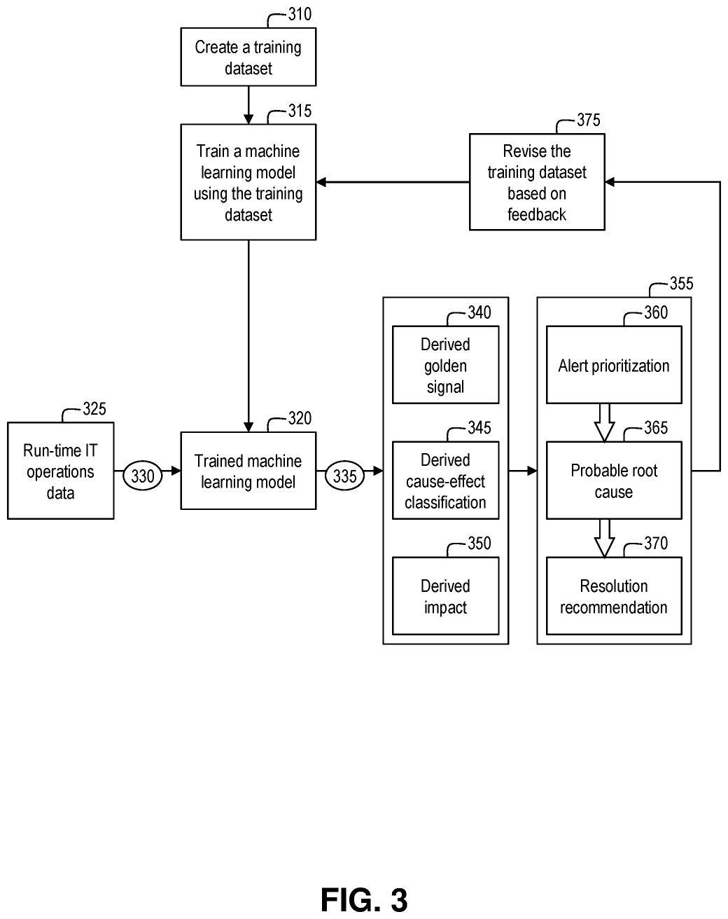

FIG. 3 shows a functional block diagram of operations in accordance with aspects of the invention. At block 310, the training module 225 of the monitoring server 220 of FIG. 2 creates (e.g., builds) a training dataset using historic IT operations data and historic event data associated with the historic IT operations data. In embodiments, the historic IT operations data comprises one or more of log data, metrics data, trace data, and topology data associated with a catalog of known events that occurred in the computer system 205. In embodiments, the historic event data comprises one or more of ticket data (e.g., help desk ticket data about an event in the catalog of known events), forum data (e.g., data posted to forums about an event in the catalog of known events), and incident data (e.g., incident analysis and resolution data about an event in the catalog of known events). The catalog of known events may include thousands (or more) of known events that occurred in the computer system 205. The historic event data may include ticket data, forum data, and/or incident data associated with each of the known events. The historic IT operations data may include discrete portions (e.g., sets) of log data, metrics data, trace data, and/or topology data associated with each of the known events. The computer system 205 may obtain and store the historic IT operations data and historic event data using one or more system monitoring tools.

At block 315, the training module 225 trains a machine learning model to receive a set of historic IT operations data as input and output a golden signal classification for the set of historic IT operations data. In one example, the machine learning model comprises a support vector machine trained using the training dataset from block 310 using stochastic gradient descent (for example). In one example, the machine learning model comprises an artificial neural network trained using the training dataset from block 310 using stochastic gradient descent. Implementations of the invention are not limited to using a support vector machine or artificial neural network, and other types of machine learning model may be used. Block 320 represents the trained machine learning model. The functions performed at blocks 310 and 315 are referred to herein as an offline mode because they are performed offline with historic data as opposed to being performed with run-time data.

With continued reference to FIG. 3, block 325 represents run-time IT operations data of the computer system 205 of FIG. 2. In embodiments, the run-time IT operations data comprises the same types of data as the historic IT operations data (e.g., log data, metrics data, trace data, and topology data), where the run-time IT operations data is associated with one or more current processes of the computer system 205 as opposed to the historic IT operations data that is associated with past processes of the computer system 205. The computer system 205 may obtain the run-time IT operations data using the same system monitoring tool(s) that are used to obtain the historic IT operations data. In embodiments, the monitoring server 220 receives the run-time IT operations data from the computer system 205, e.g., via the network 215.

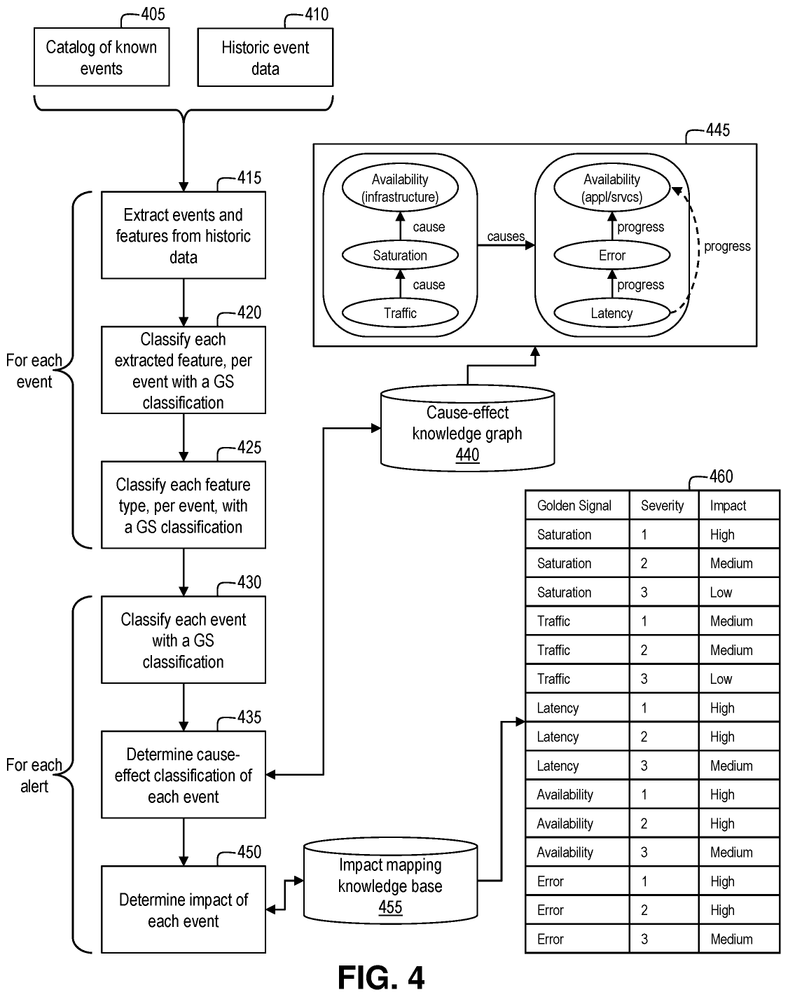

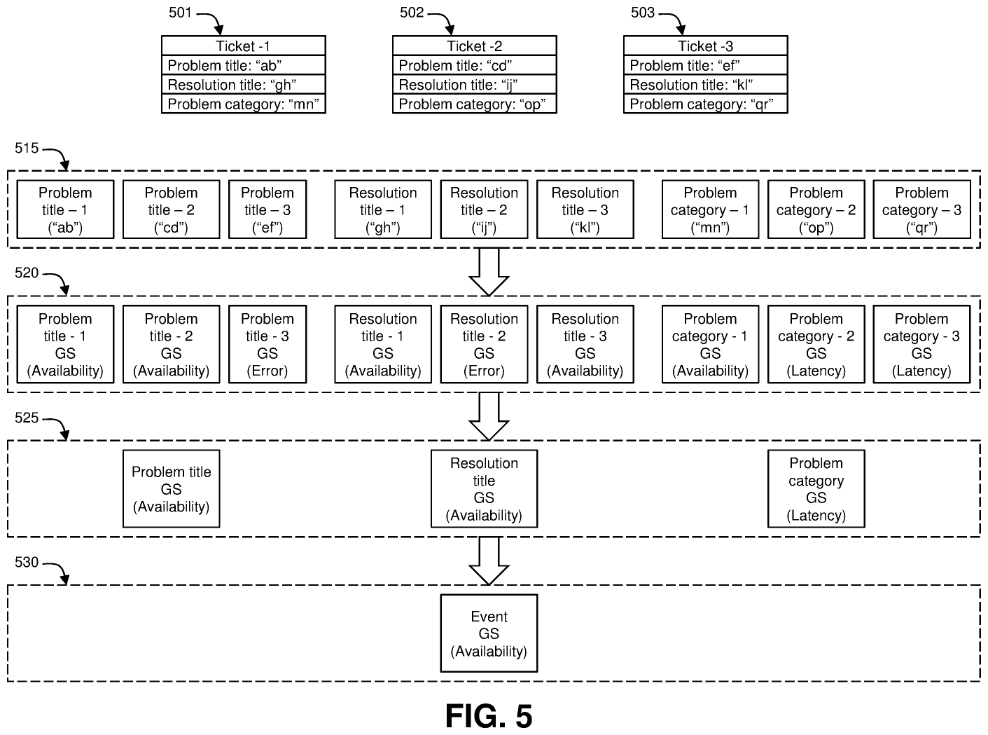

Arrow 330 of FIG. 3 represents inputting the run-time IT operations data to the trained machine learning model. Arrow 335 of FIG. 3 represents the trained machine learning model generating an output based on the run-time IT operations data that was input. In embodiments, the output comprises a golden signal classification (referred to herein as a derived golden signal) for the particular run-time IT operations data that was input to the trained machine learning model, as shown in block 340. Block 345 represents a derived cause-effect classification associated with the derived golden signal and the particular run-time IT operations data. Block 350 represents a derived impact associated with the derived golden signal and the particular run-time IT operations data. In embodiments, the classifying module 230 of the monitoring server 220 of FIG. 2 performs the functions associated with arrows 330 and 335 for determining the derived golden signal, the derived cause-effect classification, and the derived impact at blocks 340, 345, and 350 respectively. Additional details of determining the derived golden signal, the derived cause-effect classification, and the derived impact are described herein with respect to FIGS. 4 and 5.

Still referring to FIG. 3, at block 355 the diagnosis and remediation module 235 of the monitoring server 220 of FIG. 2 uses the derived golden signal, the derived cause-effect classification, and the derived impact to generate an alert prioritization shown at block 360, a probable root cause shown at block 365, and a resolution recommendation shown at block 370. At block 375, the system revises the training dataset based on feedback received in response to one or more of blocks 360, 365, and 370. One or more aspects of block 375 may be performed manually so that there is a human-in-the-loop (HITL). Following block 375, the system retrains the machine learning model at block 315 using the revised dataset from block 375, and the process may continue with the next set of run-time IT operations data at step 325. The functions performed at arrows 330 and 335 and with respect to blocks 340, 345, 350, 355, and 375 are referred to herein as an online mode because they are performed with run-time data associated with current processes of the computer system 205.

In accordance with aspects of the invention, the diagnosis and remediation module 235 determines the alert prioritization at block 360 using the golden signal classification, cause-effect classification, derived impact associated with each alert, and the domain knowledge graph.

In accordance with aspects of the invention, the probable root cause shown at block 365 may be used to exploit the derived golden signal and cause-effect relationship to annotate the alerts. In embodiments, given the topological relationships, the diagnosis and remediation module 235 annotates the alerts on the nodes in the topology with the golden signal and cause-effect relationship. The diagnosis and remediation module 235 may then rank the candidate probable cause nodes based on the golden signal and cause-effect relation domain knowledge.

In accordance with aspects of the invention, at the resolution recommendation shown at block 370, the diagnosis and remediation module 235 retrieves a resolution per alert (e.g., alerts that are deemed worthy of site reliability engineer attention) within the alert group. In one example, the diagnosis and remediation module 235 groups the retrieved resolutions across multiple alerts that are classified as type cause. In embodiments, the diagnosis and remediation module 235 ranks the resolutions within each group of resolutions based on predefined rules. For example, these rules may rank the target resolutions based on those dealing with traffic and saturation. The predefined rules may be configured by a subject matter expert (SME). The diagnosis and remediation module 235 may then group the resolutions across multiple alerts that are of type effect. For example, the diagnosis and remediation module 235 may rank the resolutions within each group of resolutions based on predefined rules. For example, these rules may rank the target resolutions based on those dealing with latency, error, and availability. The predefined rules may be configured by a subject matter expert (SME).

FIG. 4 shows a functional block diagram of offline operations in accordance with aspects of the invention. In embodiments, the training module 225 of the monitoring server 220 of FIG. 2 performs the functions described with respect to FIG. 4. In embodiments, blocks 415, 420, and 425 of FIG. 4 are performed for each event extracted from the catalog of known events, and blocks 430, 435, and 450 are performed for each alert. As described herein, events are triggered by a monitoring system that monitors different sources of information in the computer system 205. A group of events may form an alert, and a group of alerts may form an incident.

Block 405 of FIG. 4 represents the catalog of known events. As described with respect to FIG. 3, the catalog of known events may include thousands (or more) of known events that occurred in the computer system 205. The catalog of known events may include the historic IT operations data (e.g., log data, metrics data, trace data, and topology data) for each of the events in the catalog. Block 410 represents the historic event data, such as forum data, ticket data, and/or incident data, e.g., as described with respect to FIG. 3.

At block 415, the training module 225 of the monitoring server 220 of FIG. 2 extracts events and features from the historic data (i.e., the catalog of known events 405 and the historic event data 410). Features are also referred to as metadata. In embodiments, types of features may include, for example and without limitation: a problem title; a resolution title; a problem category; a problem subcategory; a severity of a ticket; an impact of a ticket; an amount of time it took to resolve a ticket; and a number of interactions that occurred between a subject matter expert and a customer in resolving a ticket. The training module 225 may use one or more natural language processing techniques to extract the events and features from the various text sources in the historic data. In embodiments, the training module 225 extracts plural events from the catalog of known events 405. In embodiments, for each extracted event, the training module 225 extracts plural features extracted from the historic event data 410 (e.g., plural tickets) associated with the event.

At block 420, for each extracted event, the training module 225 classifies each extracted feature from block 415 with a golden signal classification. The features may be classified automatically or manually. In an automated implementation, the training module 225 classifies each feature using a classification model that receives the text of the feature as input and that outputs a golden signal classification for the feature. In a manual implementation, a subject matter expert manually classifies each feature.

At block 425, for each extracted event, the training module 225 classifies each feature type with a golden signal classification based on the golden signal classifications of the features within that feature type for this particular event (e.g., from block 420). In embodiments, the training module 225 uses an ensemble technique to determine a golden signal classification for a feature type based on the golden signal classifications of the features within that feature type. In one example, the training module 225 uses majority voting or weighted score technique to classify a feature type based on the golden signal classifications of the features within that feature type.

At block 430, for each extracted event, the training module 225 classifies the event with a golden signal classification based on the golden signal classifications of the features types within that event (e.g., from block 425). In embodiments, the training module 225 uses an ensemble technique to determine a golden signal classification for an event based on the golden signal classifications of the features types within that event. In one example, the training module 225 uses a majority voting or weighted score technique to classify an event based on the golden signal classifications of the feature types within that event.

At step 435, for each extracted event, the training module 225 determines a cause-effect classification of the event. In embodiments, the training module 225 determines the cause-effect classification using a knowledge graph 440 that correlates golden signal classification to cause-effect classification. An example of the knowledge graph 440 is shown at block 445. In the example shown in block 445, golden signal classifications of availability at the infrastructure layer, saturation, and traffic are deemed causes. In the example shown in block 445, golden signal classifications of availability at the application/services layer, error, and latency are deemed effects. Using the example knowledge graph shown at block 445, an event classified as “saturation” at block 430 would be assigned a cause-effect classification of “cause” at block 435.

At step 450, for each extracted event, the training module 225 determines the impact of the event. In embodiments, the training module 225 determines the impact using a knowledge base 455 that correlates golden signal classification and severity to impact. An example of the knowledge base 455 is shown at block 460. In the example shown in block 460, the knowledge base defines different impacts (e.g., high, medium, low) for different combinations of golden signal classification (e.g., saturation, traffic, latency, availability, and error) and severity (e.g., 1, 2, 3). Severity of an event may be determined from the historic event data 410, e.g., from tickets associated with the event. Using the example knowledge base shown at block 460, an event classified as “saturation” at block 430 with a severity of “2” would be assigned an impact of “medium” at block 450.

As noted herein, some site reliability engineering best practices define golden signals as latency, traffic, errors, and saturation. Implementations of the invention may utilize this set of golden signal classifications (e.g., latency, traffic, errors, and saturation). Implementations of the invention may alternatively utilize a different predefined set of golden signal classifications, such as saturation, traffic, latency, availability, and error as shown at block 460 of FIG. 4. In either implementation, the same predefined set of golden signal classifications is used with all steps and data structures at blocks 340, 420, 425, 430, 440, and 455.

In this manner, the system determines a golden signal classification, cause-effect classification, and impact for each event extracted from the catalog of known events. In embodiments, an event's golden signal classification, cause-effect classification, and impact, determined in the manner described in FIG. 4, is combined with the historic IT operations data associated with the event to generate a respective data vector in the training dataset. In this manner, the system links the event golden signal classification, the event cause-effect classification, and the event impact with a subset of the historic information technology (IT) operations data associated with the event. In embodiments, the training module 225 generates thousands (or tens of thousands) of such data vectors for inclusion in the training dataset (shown at block 310 of FIG. 3) that is used to train the machine learning model (shown at block 320 of FIG. 3).

FIG. 5 shows an exemplary use case of performing the steps of 415, 420, 425, and 430 of FIG. 4. In this example, there are three tickets 501, 502, 503 associated with an event in the known event catalog. In this example, each ticket 501, 502, 503 includes metadata in three feature types: Problem title, Resolution title, and Problem category. These numbers of tickets and feature types are examples, and other numbers may be present in actual implementations.

Block 515 of FIG. 5 corresponds to block 415 of FIG. 4 in which the system extracts the features (e.g., metadata) for the features types in each of the respective tickets. In this example, the for the feature type Problem title, the first ticket has feature “ab”, the second ticket has feature “cd”, and the third ticket has feature “ef”. In this example, the for the feature type Resolution title, the first ticket has feature “gh”, the second ticket has feature “ij”, and the third ticket has feature “kl”. In this example, the for the feature type Problem category, the first ticket has feature “mn”, the second ticket has feature “op”, and the third ticket has feature “qr”. These examples of features (e.g., “ab”, etc.) are for illustrative purposes. Other features may be present in the tickets in actual implementations.

Block 520 of FIG. 5 corresponds to block 420 of FIG. 4 in which the system classifies the extracted features (e.g., metadata) with a golden signal classification. In this example, the feature “ab” is classified with the golden signal classification Availability, the feature “cd” is classified with the golden signal classification Availability, and the feature “ef” is classified with the golden signal classification Error. Also in this example, the feature “gh” is classified with the golden signal classification Availability, the feature “ij” is classified with the golden signal classification Error, and the feature “kl” is classified with the golden signal classification Availability. Also in this example, the feature “mn” is classified with the golden signal classification Availability, the feature “op” is classified with the golden signal classification Latency, and the feature “qr” is classified with the golden signal classification Latency. In embodiments, and as described at block 420 of FIG. 4, the training module 225 determines these golden signal classifications by applying a text-based classifier to the extracted features.

Block 525 of FIG. 5 corresponds to block 425 of FIG. 4 in which the system classifies each feature type with a golden signal classification. In embodiments, and as described with respect to FIG. 4, the training module 225 uses an ensemble technique to determine a golden signal classification for a feature type based on the golden signal classifications of the features within that feature type. In the example of FIG. 5, the training module 225 uses majority voting technique. In this example, for the feature type Problem title, two of the features are classified as Availability and one of the features is classified as Error. As such, the system classifies the feature type Problem title as Availability. Continuing this example, the system classifies the feature type Resolution title as Availability and classifies the feature type Problem category as Latency using the majority voting technique based on the classified features within each feature type.

Block 530 of FIG. 5 corresponds to block 430 of FIG. 4 in which the system classifies the event with a golden signal classification. In embodiments, and as described with respect to FIG. 4, the training module 225 uses an ensemble technique to determine a golden signal classification for the event based on the golden signal classifications of the feature types within that event. In the example of FIG. 5, the training module 225 uses the majority voting technique. In this example, there are three feature types classified as Availability, Availability, and Latency. As such, the system classifies the event as Availability.

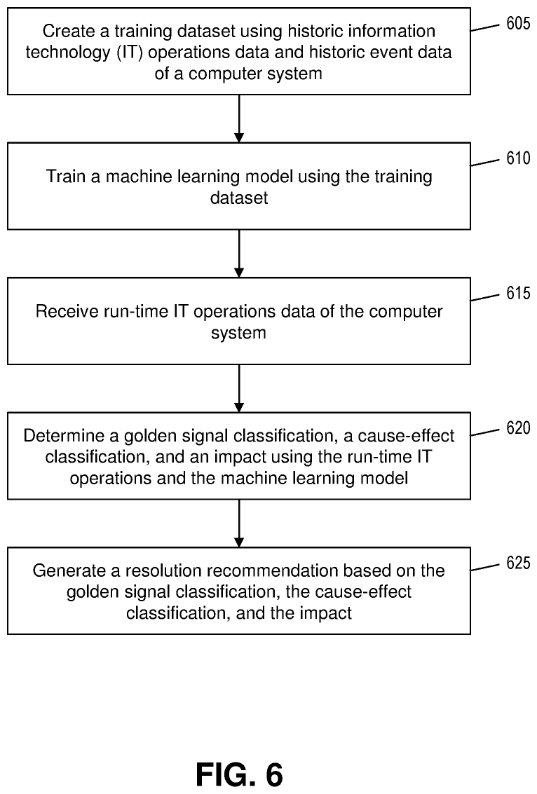

FIG. 6 shows a flowchart of an exemplary method in accordance with aspects of the present invention. Steps of the method may be carried out in the environment of FIG. 2 and are described with reference to elements depicted in FIGS. 2-5.

At step 605, the system creates a training dataset using historic information technology (IT) operations data and historic event data of a computer system. As described with respect to FIGS. 3-5, the creating the training dataset may comprise: extracting features associated with an event from the historic event data; determining a feature golden signal classification for each of the extracted features; determining a feature type golden signal classification based on the feature golden signal classification of groups of the extracted features; determining an event golden signal classification for the event based on the feature type golden signal classification of groups of the plural feature types; determining an event cause-effect classification for the event based on the event golden signal classification and a knowledge graph; determining an event impact for the event based on the event golden signal classification and a knowledge base; and linking the event golden signal classification, the event cause-effect classification, and the event impact with a subset of the historic information technology (IT) operations data associated with the event.

At step 610, the system trains a machine learning model using the training dataset. As described herein, the machine learning model may comprise a support vector machine or an artificial neural network, for example, trained using the training dataset from block 310 using stochastic gradient descent.

At step 615, the system receives run-time IT operations data of the computer system. At step 620, the system determines a golden signal classification, a cause-effect classification, and an impact using the run-time IT operations and the machine learning model. In embodiments, and as described with respect to FIGS. 2 and 3, the classifying module 230 inputs the run-time IT operations data into the trained machine learning model from step 610, and the model outputs a golden signal classification, a cause-effect classification, and an impact for this particular run-time IT operations data.

At step 625, the system generates a resolution recommendation based on the golden signal classification, the cause-effect classification, and the impact. In embodiments, the diagnosis and remediation module 235 generates a resolution recommendation, which may be provided (e.g., output) to a site reliability engineer so that this person can institute remediation action(s) based on the resolution recommendation.

The method may further include receiving feedback in response to the resolution recommendation and retraining the machine learning model based on the feedback, e.g., as described at block 375 of FIG. 3. The method may further include determining an alert prioritization and a probable root cause based on the golden signal classification, the cause-effect classification, and the impact, e.g., as described at blocks 360 and 365 of FIG. 3.

In embodiments, a service provider could offer to perform the processes described herein. In this case, the service provider can create, maintain, deploy, support, etc., the computer infrastructure that performs the process steps of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, the invention provides a computer-implemented method, via a network. In this case, a computer infrastructure, such as computer 101 of FIG. 1, can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer 101 of FIG. 1, from a computer readable medium; (2) adding one or more computing devices to the computer infrastructure; and (3) incorporating and/or modifying one or more existing systems of the computer infrastructure to enable the computer infrastructure to perform the processes of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
creating, by a processor set, a training dataset using historic information technology (IT) operations data and historic event data of a computer system;
training, by the processor set, a machine learning model using the training dataset;
receiving, by the processor set, run-time IT operations data of the computer system;
determining, by the processor set, a golden signal classification, a cause-effect classification, and an impact using the run-time IT operations and the machine learning model; and
generating, by the processor set, a resolution recommendation based on the golden signal classification, the cause-effect classification, and the impact.

2. The method of claim 1, wherein the creating the training dataset comprises:
extracting features associated with an event from the historic event data;
determining a feature golden signal classification for each of the extracted features;
determining a feature type golden signal classification based on the feature golden signal classification of groups of the extracted features; and
determining an event golden signal classification for the event based on the feature type golden signal classification of groups of the plural feature types.

3. The method of claim 2, wherein the creating the training dataset comprises:
determining an event cause-effect classification for the event based on the event golden signal classification and a knowledge graph.

4. The method of claim 3, wherein the creating the training dataset comprises:
determining an event impact for the event based on the event golden signal classification and a knowledge base.

5. The method of claim 4, wherein the creating the training dataset comprises:
linking the event golden signal classification, the event cause-effect classification, and the event impact with a subset of the historic information technology (IT) operations data associated with the event.

6. The method of claim 1, further comprising:
receiving feedback in response to the resolution recommendation; and
retraining the machine learning model based on the feedback.

7. The method of claim 1, further comprising:
determining an alert prioritization and a probable root cause based on the golden signal classification, the cause-effect classification, and the impact.

8. A computer program product comprising one or more computer readable storage media having program instructions collectively stored on the one or more computer readable storage media, the program instructions executable to:
create a training dataset using historic information technology (IT) operations data and historic event data of a computer system;
train a machine learning model using the training dataset;
receive run-time IT operations data of the computer system;
determine a golden signal classification, a cause-effect classification, and an impact using the run-time IT operations and the machine learning model; and
generate a resolution recommendation based on the golden signal classification, the cause-effect classification, and the impact.

9. The computer program product of claim 8, wherein the creating the training dataset comprises:
extracting features associated with an event from the historic event data;
determining a feature golden signal classification for each of the extracted features;
determining a feature type golden signal classification based on the feature golden signal classification of groups of the extracted features; and
determining an event golden signal classification for the event based on the feature type golden signal classification of groups of the plural feature types.

10. The computer program product of claim 9, wherein the creating the training dataset comprises:
determining an event cause-effect classification for the event based on the event golden signal classification and a knowledge graph.

11. The computer program product of claim 10, wherein the creating the training dataset comprises:
determining an event impact for the event based on the event golden signal classification and a knowledge base.

12. The computer program product of claim 11, wherein the creating the training dataset comprises:
linking the event golden signal classification, the event cause-effect classification, and the event impact with a subset of the historic information technology (IT) operations data associated with the event.

13. The computer program product of claim 8, wherein the program instructions are executable to:
receive feedback in response to the resolution recommendation; and
retrain the machine learning model based on the feedback.

14. The computer program product of claim 8, wherein the program instructions are executable to:
determine an alert prioritization and a probable root cause based on the golden signal classification, the cause-effect classification, and the impact.

15. A system comprising:
a processor set, one or more computer readable storage media, and program instructions collectively stored on the one or more computer readable storage media, the program instructions executable to:
create a training dataset using historic information technology (IT) operations data and historic event data of a computer system;
train a machine learning model using the training dataset;
receive run-time IT operations data of the computer system;
determine a golden signal classification, a cause-effect classification, and an impact using the run-time IT operations and the machine learning model; and
generate a resolution recommendation based on the golden signal classification, the cause-effect classification, and the impact.

16. The system of claim 15, wherein the creating the training dataset comprises:
extracting features associated with an event from the historic event data;
determining a feature golden signal classification for each of the extracted features;
determining a feature type golden signal classification based on the feature golden signal classification of groups of the extracted features; and
determining an event golden signal classification for the event based on the feature type golden signal classification of groups of the plural feature types.

17. The system of claim 16, wherein the creating the training dataset comprises:
determining an event cause-effect classification for the event based on the event golden signal classification and a knowledge graph.

18. The system of claim 17, wherein the creating the training dataset comprises:
determining an event impact for the event based on the event golden signal classification and a knowledge base.

19. The system of claim 18, wherein the creating the training dataset comprises:
linking the event golden signal classification, the event cause-effect classification, and the event impact with a subset of the historic information technology (IT) operations data associated with the event.

20. The system of claim 15, wherein the program instructions are executable to:
receive feedback in response to the resolution recommendation; and
retrain the machine learning model based on the feedback.
